(19) United States
(12) Patent Application Publication
(10) Pub. No.: US 2020/0012309 A1
(43) Pub. Date: Jan. 9, 2020

(54) UNIVERSAL WORK VEHICLE CONTROL GRIP

(71) Applicant: Deere & Company, Moline, IL (US)

(72) Inventors: Giovanni A. WUISAN, Epworth, IA (US); Ronald J. HUBER, Dubuque, IA (US); Matthew Q. McGRATH, Dubuque, IA (US)

(21) Appl. No.: 16/030,367

(22) Filed: Jul. 9, 2018

(51) Int. Cl. G05G 1/06; E02F 9/20; G05G 1/02

(52) U.S. Cl. CPC G05G 1/06; G05G 1/02; E02F 9/2004

(57) ABSTRACT

A control grip for a work vehicle. The control grip comprises a front shell comprising a left side, a right side, a head portion, a middle portion coupled to the head portion, and a lower portion coupled to the middle portion. A rear shell is coupled to the front shell. A faceplate is coupled to the head portion of the front shell. At least one side plate is coupled to at least one of the left side and the right side of the middle portion of the front shell, the side plate comprises a side plate control configured to control an operation of the work vehicle.

### FIELD OF THE DISCLOSURE

The present disclosure generally relates to work vehicle control grips, and more particularly to a system and method for controlling a work vehicle with one or more control grips.

### BACKGROUND OF THE DISCLOSURE

In order to control a work vehicle, the work vehicle commonly has a steering wheel or joystick that is grasped by an operator's hand or depressed by an operator's foot.

### SUMMARY OF THE DISCLOSURE

In one embodiment, a control grip for a work vehicle is disclosed. The control grip comprises a front shell comprising a left side, a right side, a head portion, a middle portion coupled to the head portion, and a lower portion coupled to the middle portion. A rear shell is coupled to the front shell. A faceplate is coupled to the head portion of the front shell. At least one side plate is coupled to at least one of the rear shell and the left side and the right side of the middle portion of the front shell, the side plate comprises a side plate control configured to control an operation of the work vehicle.

In another embodiment, a control grip system for a work vehicle is disclosed. A first control grip comprises a first front shell comprising a first left side, a first right side, a first head portion, a first middle portion coupled to the first head portion, and a first lower portion coupled to the first middle portion. A first rear shell is coupled to the first front shell. A first faceplate is coupled to the first head portion of the first front shell. A first side plate is coupled to the first right side of the first middle portion of the first front shell, the first side plate comprising a first side plate control configured to control an operation of the work vehicle. A second control grip comprises a second front shell comprising a second left side, a second right side, a second head portion, a second middle portion coupled to the second head portion, and a second lower portion coupled to the second middle portion. A second rear shell is coupled to the second front shell. A second faceplate is coupled to the second head portion of the second front shell. A second side plate is coupled to the second left side of the second middle portion of the second front shell, the second side plate comprising a second side plate control configured to control an operation of the work vehicle.

In yet another embodiment, a method for controlling a work vehicle is disclosed. The method comprises providing a control grip for a work vehicle comprising a front shell comprising a left side, a right side, a head portion, a middle portion coupled to the head portion, and a lower portion coupled to the middle portion. The method further comprises providing a rear shell coupled to the front shell. The method comprises providing a faceplate coupled to the head portion of the front shell. The method further comprises providing at least one side plate coupled to at least one of the rear shell and the left side and the right side of the middle portion of the front shell, the side plate comprising a side plate control. The method comprises operating the side plate control to control an operation of the work vehicle.

Other features and aspects will become apparent by consideration of the detailed description and accompanying drawings.

### BRIEF DESCRIPTION OF THE DRAWINGS

FIG. 1 is a perspective view of a work vehicle with a control grip system according to one embodiment.

FIG. 2 is a front view of the control grip system of the work vehicle of FIG. 1.

FIG. 3 is a rear view of the control grip system of the work vehicle of FIG. 1.

FIG. 4 is a front view of a control grip system according to another embodiment.

FIG. 5 is a rear view of a control grip system according to the embodiment of FIG. 4.

FIG. 6 is a schematic of an illustrative method for operating a work vehicle with a control grip.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION

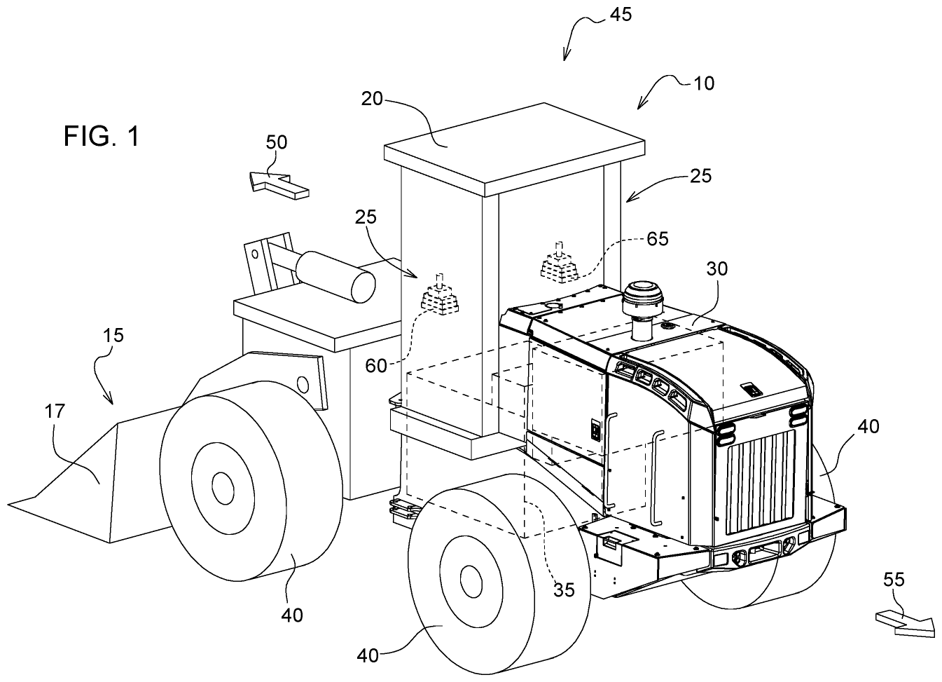

FIG. 1 illustrates a work vehicle 10 having an attachment 15. The illustrated attachment 15 is a bucket 17. Other attachments 15 may be coupled to the work vehicle 10 including forks, for example. The work vehicle 10 includes an operator station 20 having a control grip system 25 for controlling operation of the work vehicle 10. The work vehicle 10 is powered by an engine 30 that is coupled to a transmission 35 for transferring power to a plurality of ground engaging devices 40 that may be wheels or tracks. The engine 30 may be a diesel engine.

The illustrated work vehicle 10 is a wheel loader 45. Other work vehicles 10 are contemplated by this disclosure including crawlers, skidders, feller bunchers, and other forestry, construction, and road building work vehicles. The work vehicle 10 may be controlled by an operator located in the operator station 20. Using the control grip system 25 and other controls, the operator may control operations of the work vehicle 10 including commanding the work vehicle 10 to move forward 50, move backward or in reverse 55, turn, and operate the bucket 17. For other work vehicles 10 the operations may include moving a boom, operating a harvester head, controlling a ripper, moving a blade, or other. In the case of the work vehicle 10, those commands may be sent to hydraulic pumps, driven by the engine 30, which may direct pressurized hydraulic fluid to hydraulic motors that turn wheels or tracks. Alternatively, the wheel or tracks and bucket 17 may be moved by electric motors.

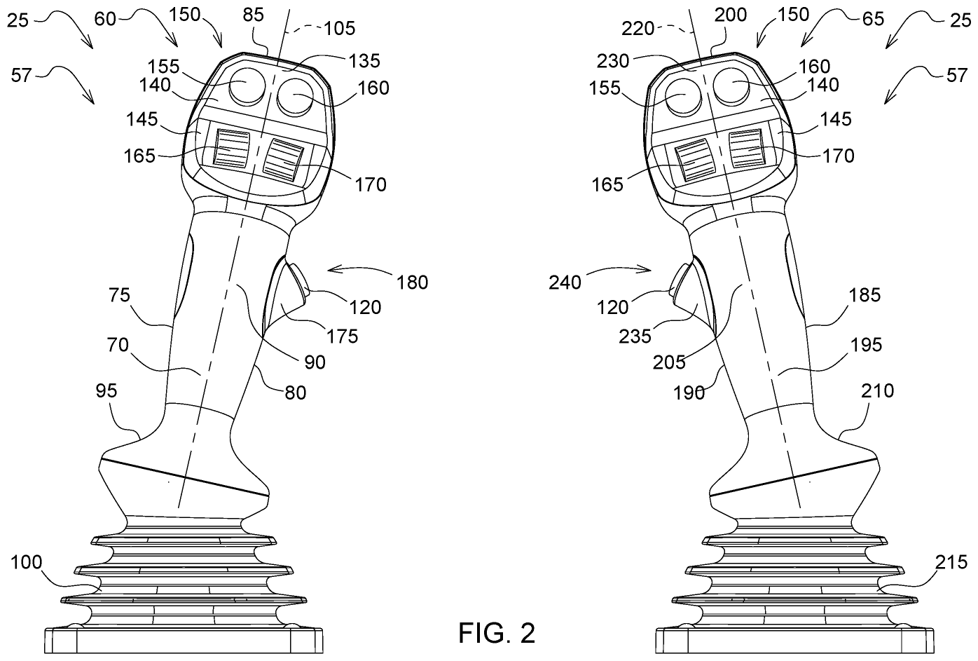

Referring to FIG. 2, the control grip system 25 comprises a control grip 57. The control grip 57 may be a first control grip 60 and a second control grip 65 both having interchangeable sections depending on the work vehicle 10 application. Alternatively, just one control grip 57 may be used. The first control grip 60 and the second control grip 65 may be positioned in a vertical orientation like a pistol grip (FIG. 1) or in a horizontal orientation like a T-grip. The diameter of the first control grip 60 and the second control grip 65 may be approximately 38 mm plus or minus 10 mm.

The first control grip 60 comprises a first front shell 70 having a first left side 75, a first right side 80, a first head portion 85, a first middle portion 90 coupled to the first head portion 85, and a first lower portion 95 coupled to the first middle portion 90. Alternatively, the first control grip 60 may have shells that are split into left and right as opposed to front and back. The first control grip 60 is designed to minimize pressure points so the operator can operate the first control grip 60 by holding the first head portion 85, the first middle portion 90, or the first lower portion 95, or a first lower skirt 100 that is coupled to the first lower portion 95. The first front shell 70 comprises a first central axis 105 and the first left side 75 may be symmetrical with the first right side 80 about the first central axis 105.

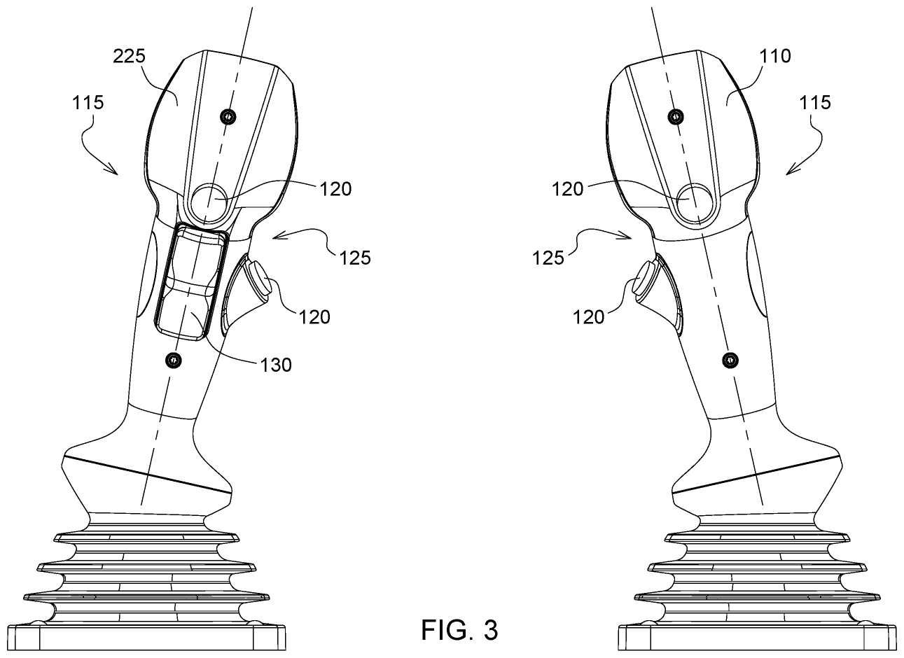

With reference to FIG. 3, a first rear shell 110 is coupled to the first front shell 70. At least one rear shell control 115 may be coupled to the first rear shell 110 and configured to control an operation of the work vehicle 10. The rear shell control 115 may be a button 120, or a multi-position switch 125, or a combination thereof. For example, the rear shell control 115 may be a 2-finger FNR or proportional rocker 130.

Referring to FIG. 2, a first faceplate 135 is coupled to the first head portion 85 of the first front shell 70. The first faceplate 135 may have multiple angles or levels including a first angle 140 and a second angle 145. At least one faceplate control 150 may be coupled to the first faceplate 135 and configured to control an operation of the work vehicle 10. The faceplate control 150 may be a button 120, or a multi-position switch 125, or a combination thereof. For example, the faceplate control 150 may also be a first button 155, a second button 160, a first multi-position switch 165, and a second multi-position switch 170.

A first side plate 175 is coupled to the first right side 80 of the first middle portion 90 of the first front shell 70. The first side plate 175 may comprise a first side plate control 180 configured to control an operation of the work vehicle 10. The first side plate control 180 may be a button 120 configured to be operated by an operator's thumb. The first side plate 175 may also be blank and with the button 120 removed, providing a thumb rest.

The second control grip 65 comprises a second front shell 185 comprising a second left side 190, a second right side 195, a second head portion 200, a second middle portion 205 coupled to the second head portion 200, and a second lower portion 210 coupled to the second middle portion 205. Alternatively, the second control grip 65 may have shells that are split into left and right as opposed to front and back. The second control grip 65 is designed to minimize pressure points so the operator can operate the second control grip 65 by holding the second head portion 200, the second middle portion 205, or the second lower portion 210, or a second lower skirt 215 that is coupled to the second lower portion 210. The second front shell 185 comprises a second central axis 220 and the second left side 190 is symmetrical with the second right side 195 about the second central axis 220.

With reference to FIG. 3, a second rear shell 225 is coupled to the second front shell 185. At least one rear shell control 115 may be coupled to the second rear shell 225 and configured to control an operation of the work vehicle 10. The rear shell control 115 may be a button 120 or a multi-position switch 125 or a combination thereof. For example, the rear shell control 115 may be a 2-finger FNR or proportional rocker 130.

Referring to FIG. 2, a second faceplate 230 is coupled to the second head portion 200 of the second front shell 185. The second faceplate 230 may have multiple angles or levels including a first angle 140 and a second angle 145. At least one faceplate control 150 may be coupled to the second faceplate 230 and configured to control an operation of the work vehicle 10. The faceplate control 150 may be a button 120 or a multi-position switch 125 or a combination thereof. For example, the faceplate control 150 may also be a first button 155, a second button 160, a first multi-position switch 165, and a second multi-position switch 170.

A second side plate 235 is coupled to the second left side 190 of the second middle portion 205 of the second front shell 185. The second side plate 235 may comprise a second side plate control 240 configured to control a second operation of the work vehicle 10. The first side plate control 180 may face towards the second side plate control 240. At least one of the first side plate control 180 and the second side plate control 240 may be at least one button 120 configured to be operated by an operator's thumb. The second side plate 235 may also be blank and with the buttons 120 removed, provide a thumb rest.

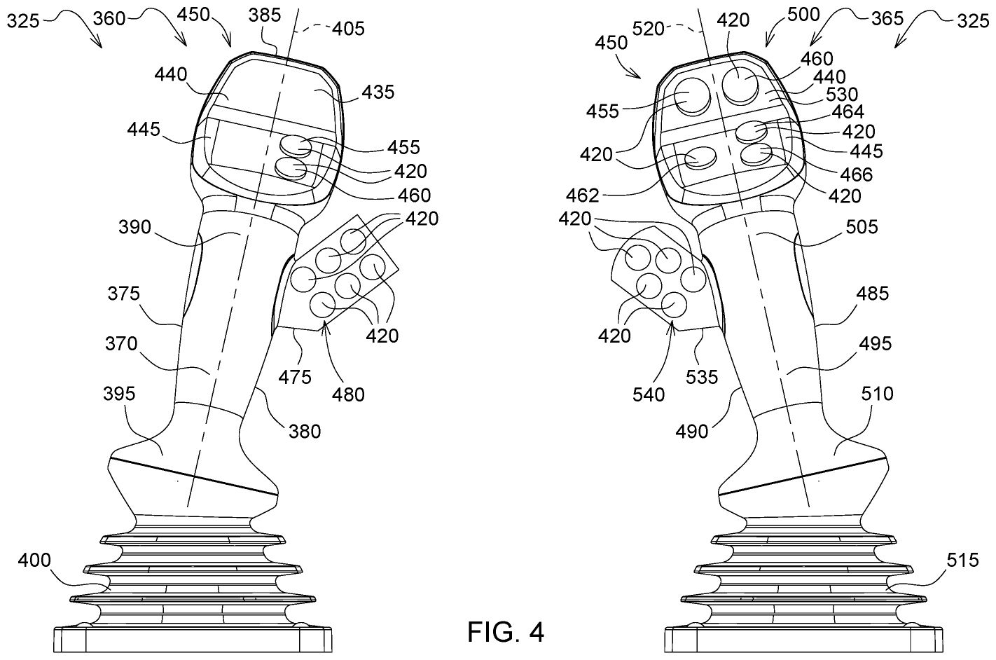

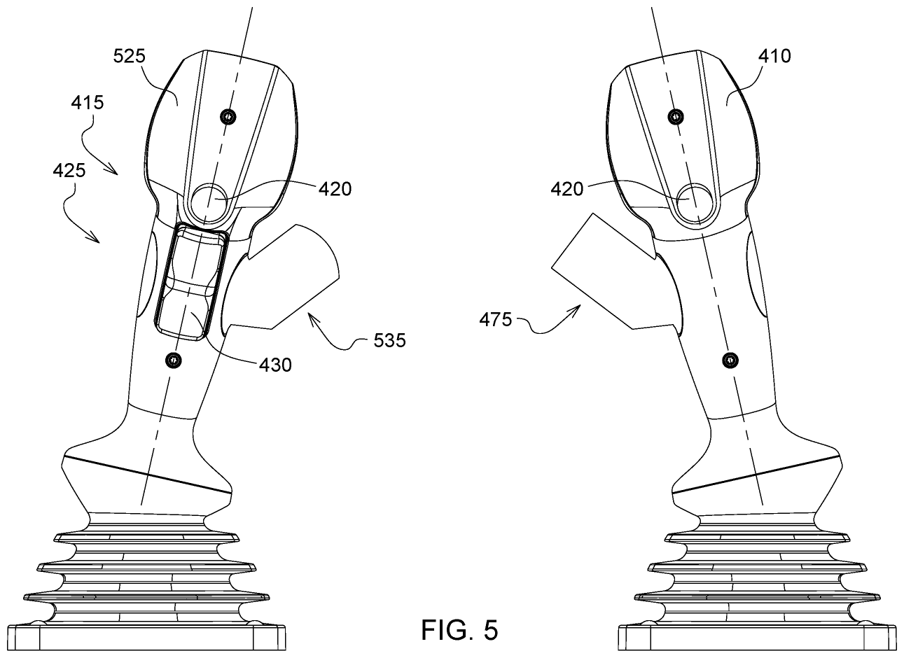

FIGS. 4 and 5 illustrate a control grip system 325 according to another embodiment. The control grip system 325 includes features similar to the control grip system 25 of FIGS. 1-3, and therefore, like components have been given like reference numerals plus 300 and only the differences between the control grip systems 25 and 325 will be discussed in detail below.

A first faceplate 435 is coupled to a first head portion 385 of a first front shell 370. The first faceplate 435 may have multiple angles or levels including a first angle 440 and a second angle 445. At least one faceplate control 450 may be coupled to the first faceplate 435 and configured to control an operation of the work vehicle 10. The faceplate control 450 may be a button 420. For example, the faceplate control 450 may also be a first button 455 and a second button 460.

A first side plate 475 is coupled to a first right side 380 of a first middle portion 390 of the first front shell 370. The first side plate 475 may comprise a first side plate control 480 configured to control an operation of the work vehicle 10. The first side plate control 480 may be a plurality of buttons 420 configured to be operated by an operator's thumb. The first side plate 475 may also be blank and with the buttons 420 removed, provide a thumb rest.

A second faceplate 530 is coupled to a second head portion 500 of a second front shell 485. The second faceplate 530 may have multiple angles or levels including a first angle 440 and a second angle 445. At least one faceplate control 450 may be coupled to the second faceplate 530 and configured to control an operation of the work vehicle 10. The faceplate control 450 may be a button 420. For example, the faceplate control 450 may also be a first button 455, a second button 460, a third button 462, a fourth button 464, and a fifth button 466.

A second side plate 535 is coupled to a second left side 490 of a second middle portion 505 of the second front shell 485. The second side plate 535 may comprise a second side plate control 540 configured to control a second operation of the work vehicle 10. The first side plate 475 may extend towards the second side plate 535. At least one of the first side plate control 480 and the second side plate control 540 may be at least one button 420 configured to be operated by an operator's thumb. The second side plate 535 may also be blank and with the buttons 420 removed, provide a thumb rest.

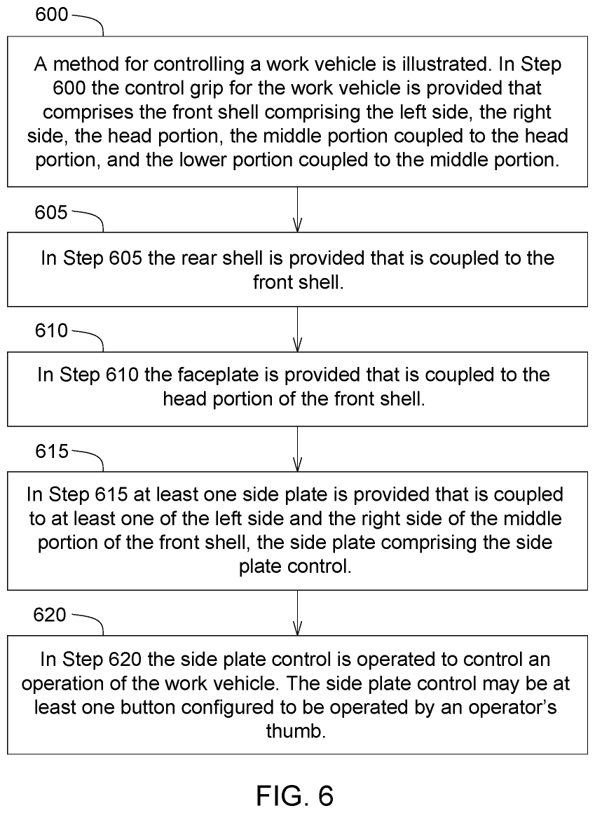

A method for controlling a work vehicle is illustrated in FIG. 6. In Step 600 the control grip 57 for the work vehicle 10 is provided that comprises the front shell 70,185 comprising the left side 75,190, the right side 80,195, the head portion 85,200, the middle portion 90,205 coupled to the head portion 85,200, and the lower portion 95,210 coupled to the middle portion 90,205. Alternatively, the control grip 57 may have shells that are split into left and right as opposed to front and back.

In Step 605 the rear shell 110,225 is provided that is coupled to the front shell 70,185. In Step 610 the faceplate 135,230 is provided that is coupled to the head portion 85,200 of the front shell 70,185.

In Step 615 at least one side plate 175,235 is provided that is coupled to at least one of the left side 75,190 and the right side 80,195 of the middle portion 90,205 of the front shell 70,185, the side plate 175,235 comprising the side plate control 180,240. In Step 620 the side plate control 180,240 is operated to control an operation of the work vehicle 10. The side plate control 180,240 may be at least one button 120 configured to be operated by an operator's thumb.

At least one rear shell control 115 may be coupled to the rear shell 110,225 and configured to control an operation of the work vehicle 10. The rear shell control 115 may be at least one of the button 120 and the multi-position switch 125.

At least one faceplate control 150 may be coupled to the faceplate 135,230 and configured to control an operation of the work vehicle 10.

What is claimed is:

1. A control grip for a work vehicle comprising:
a front shell comprising a left side, a right side, a head portion, a middle portion coupled to the head portion, and a lower portion coupled to the middle portion;
a rear shell coupled to the front shell;
a faceplate coupled to the head portion of the front shell; and
at least one side plate coupled to at least one of the rear shell and the left side and the right side of the middle portion of the front shell, the side plate comprising a side plate control configured to control an operation of the work vehicle.

2. The control grip of claim 1, wherein the front shell comprises a central axis and the left side is symmetrical with the right side about the central axis.

3. The control grip of claim 1, further comprising at least one rear shell control coupled to the rear shell and configured to control an operation of the work vehicle.

4. The control grip of claim 3, wherein the rear shell control is at least one of a button and a multi-position switch.

5. The control grip of claim 1, further comprising at least one faceplate control coupled to the faceplate and configured to control an operation of the work vehicle.

6. The control grip of claim 5, wherein the faceplate control is at least one of a button and a multi-position switch.

7. The control grip of claim 6, wherein the faceplate control comprises a first button, a second button, a first multi-position switch, and a second multi-position switch.

8. The control grip of claim 1, wherein the side plate control is at least one button configured to be operated by an operator's thumb.

9. A control grip system for a work vehicle comprising:
a first control grip comprising:
a first front shell comprising a first left side, a first right side, a first head portion, a first middle portion coupled to the first head portion, and a first lower portion coupled to the first middle portion;
a first rear shell coupled to the first front shell;
a first faceplate coupled to the first head portion of the first front shell;
a first side plate coupled to the first right side of the first middle portion of the first front shell, the first side plate comprising a first side plate control configured to control an operation of the work vehicle;
a second control grip comprising:
a second front shell comprising a second left side, a second right side, a second head portion, a second middle portion coupled to the second head portion, and a second lower portion coupled to the second middle portion;
a second rear shell coupled to the second front shell;
a second faceplate coupled to the second head portion of the second front shell; and
a second side plate coupled to the second left side of the second middle portion of the second front shell, the second side plate comprising a second side plate control configured to control an operation of the work vehicle.

10. The control grip system of claim 9, wherein the first front shell comprises a first central axis and the first left side is symmetrical with the first right side about the first central axis and the second front shell comprises a second central axis and the second left side is symmetrical with the second right side about the second central axis.

11. The control grip system of claim 9, wherein the first side plate control faces towards the second side plate control.

12. The control grip system of claim 9, further comprising at least one rear shell control coupled to at least one of the first rear shell and the second rear shell and configured to control an operation of the work vehicle.

13. The control grip system of claim 12, wherein the rear shell control is at least one of a button and a multi-position switch.

14. The control grip system of claim 9, further comprising at least one faceplate control coupled to at least one of the first faceplate and the second faceplate and configured to control an operation of the work vehicle.

15. The control grip system of claim 9, wherein at least one of the first side plate control and the second side plate control is at least one button configured to be operated by an operator's thumb.

16. A method for controlling a work vehicle, the method comprising:
providing a control grip for a work vehicle comprising a front shell comprising a left side, a right side, a head portion, a middle portion coupled to the head portion, and a lower portion coupled to the middle portion;
providing a rear shell coupled to the front shell;
providing a faceplate coupled to the head portion of the front shell; and
providing at least one side plate coupled to at least one of the rear shell and the left side and the right side of the middle portion of the front shell, the side plate comprising a side plate control; and
operating the side plate control to control an operation of the work vehicle.

17. The method of claim 16, wherein the side plate control is at least one button configured to be operated by an operator's thumb.

18. The method of claim 16, further comprising at least one rear shell control coupled to the rear shell and configured to control an operation of the work vehicle.

19. The method of claim 18, wherein the rear shell control is at least one of a button and a multi-position switch.

20. The method of claim 16, further comprising at least one faceplate control coupled to the faceplate and configured to control an operation of the work vehicle.
